(19) United States
(12) Patent Application Publication
(10) Pub. No.: US 2008/0298468 A1
(43) Pub. Date: Dec. 4, 2008

(54) ERROR TAGGING FOR DECODER

(75) Inventors: Sharath Narahari, Pleasanton, CA (US); Ramesh Duvvuru, San Jose, CA (US); Yu-Wen (Evan) Chang, Fremont, CA (US); Mohammad R. Moradi, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MediaPhy Corporation, San Jose, CA (US)

(21) Appl. No.: 12/132,696

(22) Filed: Jun. 4, 2008

Related U.S. Application Data
(60) Provisional application No. 60/941,899, filed on Jun. 4, 2007.

(51) Int. Cl. H04N 7/12; H04N 7/16

(52) U.S. Cl. 375/240.25; 725/62; 375/E07.027

(57) ABSTRACT

Systems, devices, processors, and methods are described for tagging the reliability of received data. A frame of data is received in a digitized version of a wireless signal may be received and stored in a frame memory table. Errors within the stored portion of the frame may be searched for by accessing and processing the data from the frame memory table. In a second memory table, a memory location corresponding to a region of the first memory table may be tagged based on the search. Rows to be corrected may be identified based on the tag state for their corresponding region.

### CROSS REFERENCES

This application claims priority from co-pending U.S. Provisional Patent Application No. 60/941,899, filed Jun. 4, 2007, entitled “ERROR TAGGING FOR DECODER” (Attorney Docket No. 025950-000900US), which is hereby incorporated by reference, as if set forth in full in this document, for all purposes.

### BACKGROUND

Embodiments of the present invention relate to wireless communications and mobile digital TV (MDTV) technology in general and, in particular, to tagging received data for reliability.

In wireless devices receiving digital video streams, power consumption is often a concern. Reading, writing, and storing data in memory consumes power. Certain standards, such as DVB-H standard (digital video broadcasting for handheld devices), have been developed for digital TV reception on battery-based mobile devices. DVB-H is set up to use a Reed-Solomon decoding scheme to transmit and reliably receive data. For decoders in DVB-H and other standards, significant amounts of data may be stored for the identification of reliable and unreliable datagrams. Therefore, it may be desirable to introduce novel architectures and methods which may allow for the reduction of read/write operations and lessened requirements for memory.

### SUMMARY

Novel systems, devices, and methods are described for associating a region of memory with a tag to identify data to be corrected. In one set of embodiments, a frame of data is received in a digitized version of a wireless signal. As it is received, the frame of data may be stored in a frame memory table, the frame memory table made up of a number of regions. Errors within the stored portion of the frame are searched for by accessing and processing the frame memory table. In a second memory table, a memory location corresponding to a region is tagged based on the search. Rows to be corrected may be identified based on the tag state for their corresponding region.

In some embodiments, the size of the region corresponding to the memory location may be modified. Also, the default state attributed to locations in the second memory table may be changed from indicating an error within the region to indicating no error is located within the region. These changes may be made dynamically, and may be based on a variety of signal quality metrics or the performance of a decoder.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a wireless system configured according to various embodiments of the invention.

FIG. 2 is a block diagram of the structure of a frame to be decoded according to various embodiments of the invention.

FIG. 3 is a block diagram illustrating application data for a frame to be decoded according to various embodiments of the invention.

FIG. 4 is a block diagram of a device including components configured according to various embodiments of the invention.

FIG. 5 is a block diagram of a decoder unit of a device configured according to various embodiments of the invention.

FIG. 6 is a block diagram of a decoder unit configured according to various embodiments of the invention.

FIG. 7 is a flowchart illustrating a method of error tagging according to various embodiments of the invention.

FIG. 8 is a flowchart illustrating an alternative method of error tagging according to various embodiments of the invention.

FIG. 9 is a flowchart illustrating an method of error tagging for frames of encoded data according to various embodiments of the invention.

### DETAILED DESCRIPTION

Novel systems, devices, and methods are described for associating a region of memory with a tag to identify data to be corrected. As it is received via a wireless signal, a frame of data may be stored in a frame memory table made up of a number of regions. Errors within the stored portion of the frame may be searched for by accessing and processing data from the frame memory table. In a second memory table, a memory location corresponding to a region is tagged based on the search. Rows to be corrected may be identified based on the tag state for their corresponding region.

This description provides example embodiments only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components, as appropriate. For instance, it should be appreciated that in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, and software may individually or collectively be components of a larger system, wherein other procedures may take precedence over or otherwise modify their application. Also, a number of steps may be required before, after, or concurrently with the following embodiments.

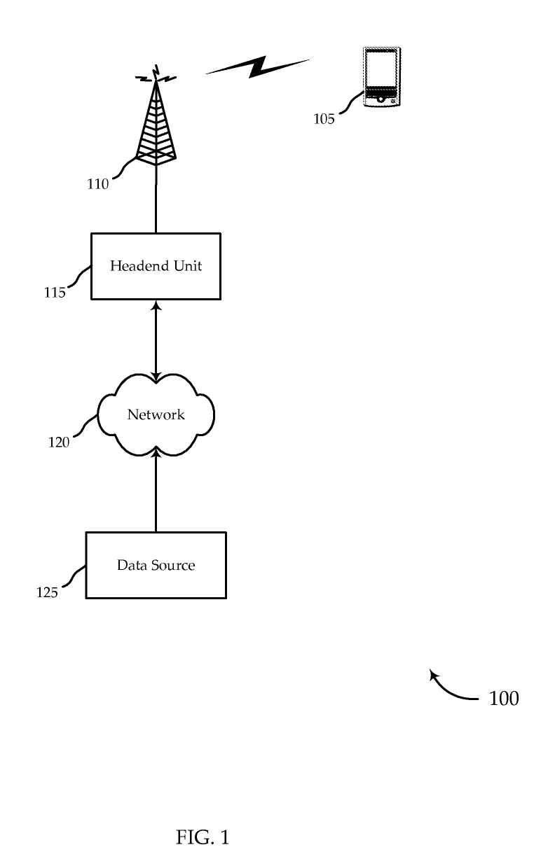

Systems, devices, processors, methods, and software are described for tagging the reliability of received data in a decoding process. Turning to FIG. 1, an example communications system 100 for implementing embodiments of the invention is illustrated. The system includes a communications device 105. The communications device 105 may be a cellular telephone, other mobile phone, personal digital assistant (PDA), portable video player, portable multimedia player, portable DVD player, laptop personal computer, a television in transportation means (including cars, buses, and trains), portable game console, digital still camera or video camcorder, or other device configured to receive wireless communications signals.

In the illustrated embodiment, the device 105 communicates with a headend unit 115 via a radio tower 110. The headend unit 115 and tower 110 may be one of a collection of base stations utilized as part of a system that communicates with the device 105 using wireless signals. The device 105 may receive a wireless signal including a series of frames of encoded data (e.g., a video broadcast signal) from the headend unit 115. Components of the device may store the frame in a frame memory table made up of a number of regions. Errors within the stored portion of the frame are searched for by accessing and processing portions of the frame memory table. A memory location corresponding to a region is tagged based on the search. These novel techniques related to the efficient tagging of errors in a received frame of data will be described in detail below.

It is worth noting that there may be a variety of different types of infrastructure network devices or sets of devices (not shown) in the system, either in the network 120 or elsewhere. These may include, for example, a Base Station Controller (BSC), or other computer or server, serving as an interface between a network 120 and the headend unit 115.

The network 120 of the illustrated embodiment may be any type of network, and may include, for example, the Internet, an IP network, an intranet, a wide-area network (WAN), a local-area network (LAN), a virtual private network (VPN), the Public Switched Telephone Network (PSTN), or any other type of network supporting data communication between any devices described herein. A network 120 may include both wired and wireless connections, including optical links. The system 100 also includes a data source 125, which may be a server or other computer configured to transmit data (video, audio, or other data) to the communications device 105 via the network 120.

It is worth noting that aspects of the present invention may be applied to a variety of devices (such as communications device 105) generally and, more specifically, may be applied to mobile digital television (MDTV) devices. Aspects of the present invention may be applied to digital video broadcast standards that are either in effect or are at various stages of development. These may include the European standard DVB-H, the Japanese standard ISDB-T, the Korean standards digital audio broadcasting (DAB)-based Terrestrial-DMB and Satellite-DMB, the Chinese standards DTV-M, Terrestrial-Mobile Multimedia Broadcasting (T-MMB), Satellite and terrestrial interaction multimedia (STiMi), and the MediaFLO format proposed by Qualcomm Inc. While certain embodiments of the present invention are described in the context of the DVB-H standard, it may also be implemented in any of the above or future standards, and as such is not limited to any one particular standard.

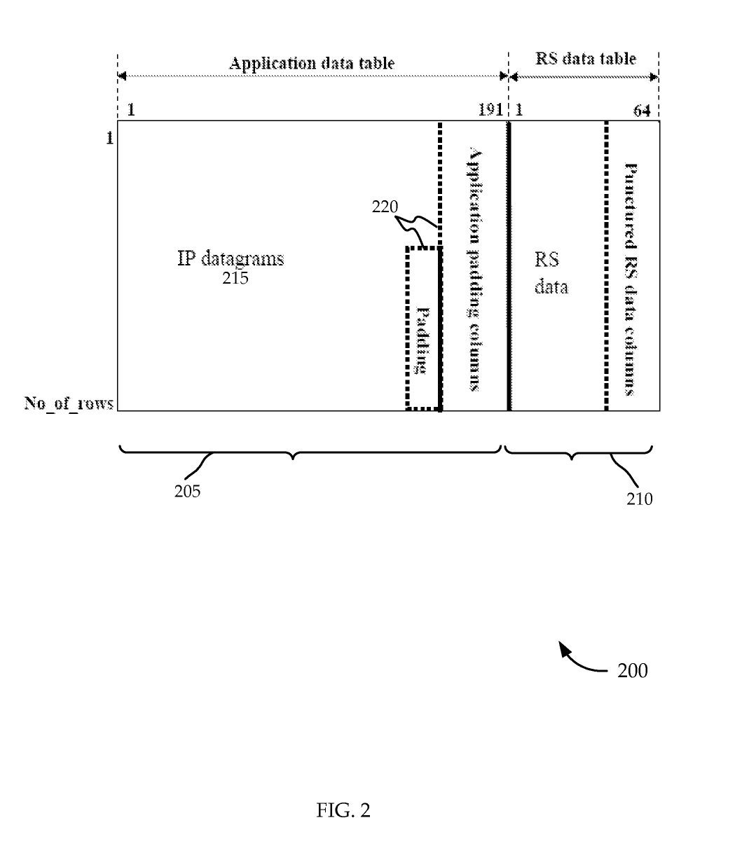

Consider first the DVB-H standard (digital video broadcasting for handheld devices), developed for digital TV reception on battery-based mobile devices, while noting that the novel aspects described herein are applicable to a number of standards. FIG. 2 illustrates a frame 200 of data (a multi-protocol encapsulation (MPE) frame) which may be formatted at the transmitter (e.g., the headend unit 115 of FIG. 1) in accordance with the DVB-H standard. Note that while the DVB-H standard is used for purposes of example, a variety of aspects of the invention are applicable to a number of other mobile digital television (MDTV) and other wireless standards, as well. Thus, embodiments of the invention may be used with frames of varying sizes and codes, so that the frame 200 is for purposes of example only.

In one embodiment, a frame 200 to be transmitted is arranged as a matrix with 255 columns of one byte each, and a flexible number of rows. The frame is filled at a transmitter, such as the headend unit 115. The number of rows may be set and signaled dynamically by transmitter, and may vary in number from one to a maximum allowed value of 1,024, which if full makes the total frame 200 almost 2 Mb in size. The left part 205 of the frame 200 is made up of the 191 columns dedicated for IP datagrams 215 and possible padding 220, and this part of the frame is called the application data table 205. The right part 210 of the frame, made up of the 64 columns on the right and dedicated for parity information of the FEC code, is called the RS data table 210. Each byte position in the application data table 205 may have an address ranging from (1 to 191)×(row number). In the same way, each byte position in the RS data table 210 may have an address ranging from (1 to 64)×(row number).

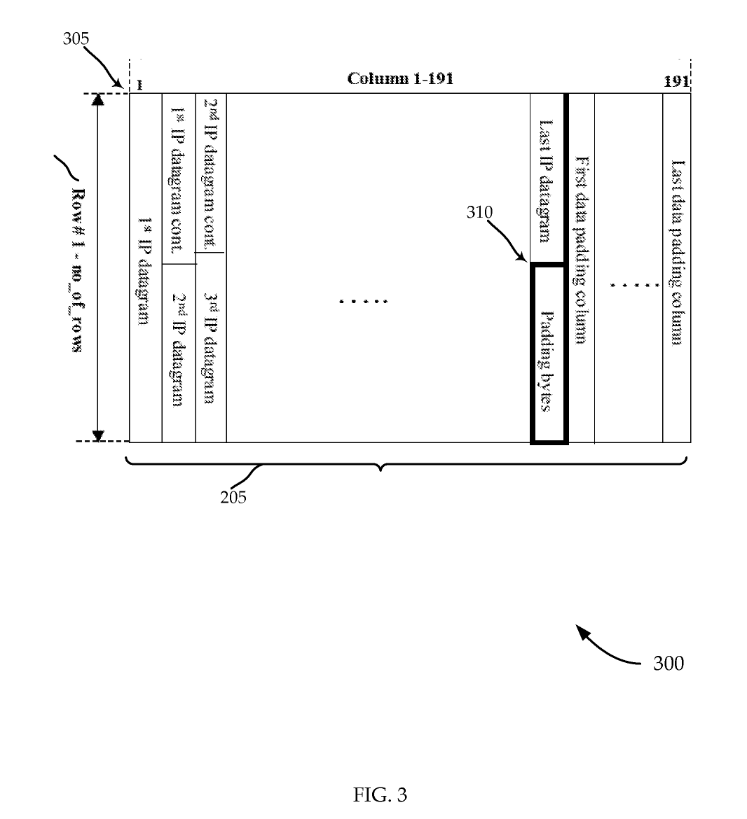

An example of the process of filling the application data table 205 is illustrated by the diagram 300 of FIG. 3, while noting that the filling process may vary significantly for other embodiments. Data is filled, starting with the first byte of a first datagram in the upper left corner 305 of the matrix and going downward in the first column. The length of the IP datagrams may vary arbitrarily from datagram to datagram. After the end of one IP datagram, the following IP datagram starts. If an IP datagram does not end precisely at the end of a column, it continues at the top of the following column. When all IP datagrams 215 have entered 310 the application data table 205, unfilled byte positions are padded 220 with zero bytes, a process which makes the leftmost 191 columns completely filled. The number of full and partial padding columns may be signalled dynamically from the transmitter.

With the application data table 205 filled, the 64 parity bytes for each row of the RS data table are calculated from the 191 bytes of IP data (and possible padding) for the row. In one embodiment, the code used is Reed-Solomon RS (255, 191) with a field generator polynomial and a code generator polynomial. Each row then contains one RS codeword. Some of the rightmost columns of the RS data table may be discarded and thus will not be transmitted, which may enable puncturing. The exact amount of punctured RS columns may not need to be explicitly signaled, and may change dynamically between frames. With these steps, the RS data table 210 is completely filled, and the frame 200 is completed. As noted above, the coding format and scheme set forth herein are for purposes of example only, and a variety of alternatives may be used.

In one embodiment, the transmitted IP data is carried in MPE sections per the DVB standard. Thus, each MPE section may carry a start address for the IP datagram. This address indicates the byte position in the application data table 205 of the first byte of the IP datagram, and is included in the MPE header. A receiver will then be able to put the received IP datagram in the right byte positions in the application data table 205 and identify particular sets of byte positions as “reliable” for the RS decoder, provided the CRC-32 or other checksum shows that the section is correct. The last section of the application data table 205 may contain a flag which indicates the end of the IP datagrams within the application data table 205. If previous sections within the application data table 205 have been received correctly, the receiver does not need to receive any additional sections, and time slicing is used, the receiver can then power off certain components. The parity bytes may be carried in a separate, specially defined section type. These are similar to MPE sections and are named MPE-FEC sections.

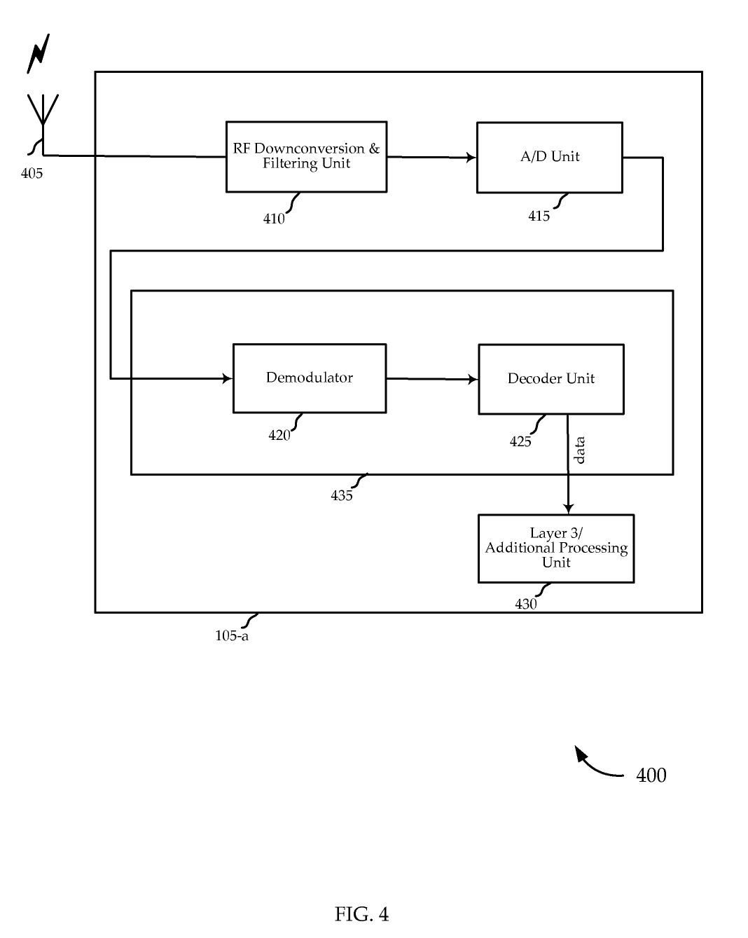

Referring to FIG. 4, an example block diagram 400 of a device 105-a is shown which illustrates various embodiments of the invention. The device 105-a may, but need not, be the device 105 of FIG. 1. The device 105-a may be configured to receive a radio frequency signal, including the frame 200 described with reference to FIG. 2. In the embodiments to now be described, assume an orthogonal frequency division multiplexing (OFDM) system is implemented, while realizing that the principles described are applicable to single or multicarrier signals in a range of both wireless and wireline systems. Also, while an assumption will be made that the system at issue implements DVB-H, embodiments of the invention may be implemented in a range of other systems.

The device 400 includes a number of receiver components, which may include: an RF down-conversion and filtering unit 410, A/D unit 415, demodulator unit 420, and decoder unit 425. The device 105-a includes one or more memory units (not explicitly shown) used for a variety of purposes. In one embodiment, the radio frequency signal including, for example, the frame 200 of FIG. 2 is received via an antenna 405. The desired signal is selected, down-converted, and filtered through the RF down-conversion and filtering unit 410. The output is converted into a digital signal by the A/D unit 415. This digitized signal is forwarded to the demodulator unit 420. The demodulator unit 420 may perform symbol synchronization, FFT processing, frequency offset correction and estimation, and equalizer functions.

The data from the demodulator unit 420 may be forwarded to the decoder unit 425. The decoder unit 425 may identify errors within a received frame, tagging the received data of the frame 200 as reliable or unreliable in the manner described herein. The decoder unit 425 may then correct the unreliable data, and this corrected data may be forwarded to a layer 3/additional processing unit 430 for further processing. It is worth noting that in one embodiment, the demodulator unit 420 and decoder unit 425 are receiver components 435 implemented in a single PHY chip. It is also worth noting that in another embodiment, the RF down-conversion and filtering unit 410, A/D unit 415, demodulator unit 420 and decoder unit 425 are receiver components implemented in a single chip with RF and PHY functionality.

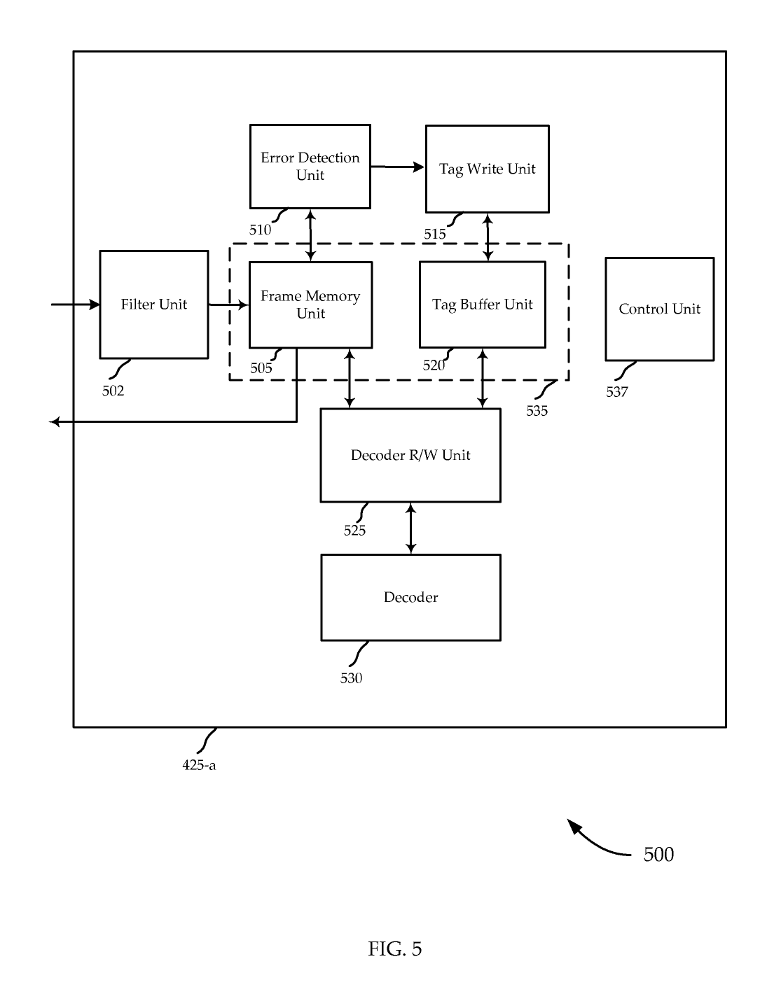

FIG. 5 is a block diagram 500 illustrating an example of a decoder unit 425-a, which may be the decoder unit 425 of FIG. 4. The decoder unit 425-a of FIG. 5 in one embodiment includes a filter unit 502, frame memory unit 505, an error detection unit 510, a tag write unit 515, a tag buffer unit 520, a decoder r/w unit 525, an RS decoder 530, and a control unit 537. In the following discussion, it may be assumed that these components will be processing a received frame 200 from FIG. 2. However, it is worth noting that a variety of other frame formats may be used in other embodiments.

In one embodiment, data from the demodulator unit 420 is received by the decoder unit 425-a as a stream of MPE sections (perhaps after some intermediate processing). The filter unit 502 may monitor the stream of MPE sections to identify MPE section headers. The filter unit 502 may pass any portion of the MPE section header to the control unit 537. The filter unit 502, control unit 537, or any combination thereof may then direct the filling of the frame memory unit 505 on a section by section basis, filling columns with the associated IP datagrams as they are received. Thus, the frame 200 from FIG. 2 may be reconstructed and buffered in the frame memory unit 505 by the control unit 537. The size of this portion of the frame memory unit 505 may be 255 bytes x the number of rows (i.e., corresponding to the size of the transmitted frame). By way of example, frame memory unit 505 may be allocated memory space for 2 frames, or have other types of permanent allocations. To determine frame 200 parameters, the number of rows for a frame 200 may be signaled, but may also be determined from the section length of the MPE-FEC sections, since the payload length of these sections may be equal to the number of rows.

As noted, to place the received packet belonging to the application data table 205 or to the RS data table 210 in the appropriate location in the frame memory unit 505, the control unit 537 (or filter unit 502) may look to the section header for the start address of the payload within the section. This procedure may result in the proper placement of packets even in the face of missing sections (e.g., because they were lost during transport). MPE and MPE-FEC sections are typically protected by a CRC-32 code, which reliably detects erroneous sections. In other embodiments, a variety of checksums may be used. Thus, errors may be detected based on a variety or error detection methods, including identification of dropped or lost packets, time outs, CRCs or checksums, among others.

In addition to the memory of the frame memory unit 505, there is additional memory made up of a tag buffer unit 520. The tag buffer unit 520 may be a smaller memory area which stores reliability information for particular regions of the frame memory unit 505. The tag buffer unit 520 may, therefore, be structured to tag particular regions of a received frame 200 stored in the frame memory unit 505 as reliable or unreliable (e.g., indicating that one or more bytes in a region storing the received frame 200 include an error).

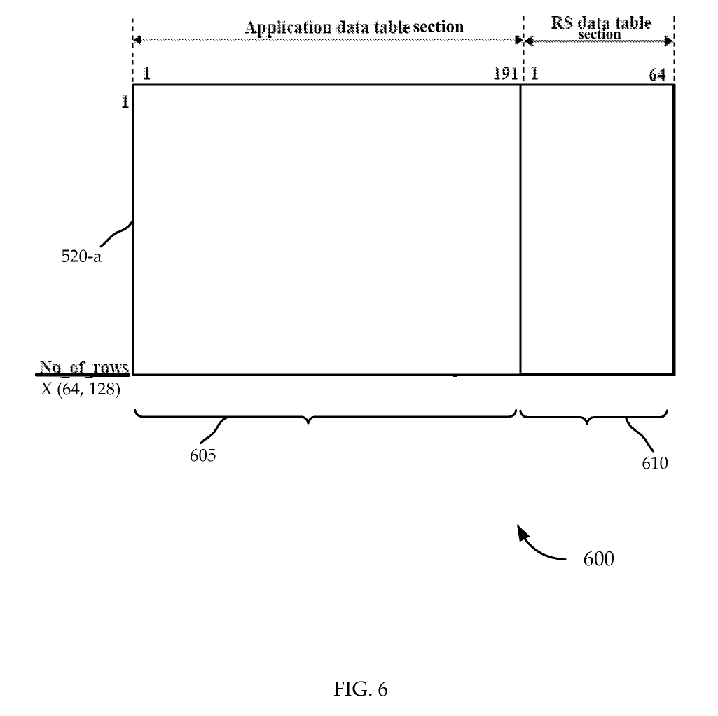

Before addressing the processing path in further detail, there will be a discussion on various example parameters for the tag buffer unit 520, and on how it may be configured and adapted in various environments. The diagram 600 of FIG. 6 is an example of a tag buffer unit 520-a, which may be the tag buffer unit 520 of FIG. 5. In one embodiment, the tag buffer unit 520-a is configured to provide reliability data (e.g., an indication of an error or an indication of no identified error) corresponding to certain “regions” or “chunks” of the received frame 200. For example, one bit in the tag buffer unit 520-a may correspond to a region of two, or more, bytes (e.g., 32, 64, or 128 bytes) of information in the frame memory unit 505.

Thus, the tag buffer unit 520-a may have sections corresponding to the parts of the frame 200 stored in frame memory unit 505, including an application data table section 605 and RS data table section 610. The tag buffer unit 520-a may be dedicated memory providing reliability information for two, or more, frames. In one embodiment, the device 105-a includes two tag buffer units 520-a, each 256 bits wide X 16 rows. In this embodiment, each bit corresponds to a 64 byte column portion of the frame. In a second embodiment, the device 105-a includes two tag buffer units 520-a, each 256 bits wide X 8 rows. In this second embodiment, each bit corresponds to a 128 byte column portion of the frame. A number of other configurations are possible, as well. For example, there may be 32 or 256 byte portions, and frames with fewer rows than 1024. In one embodiment, the region may correspond to two or more, columns of bytes.

Turning the discussion back to FIG. 5, instead of having dedicated tag buffer units 520, the dirty bit buffer units may utilize shared memory 535. Similarly, the frame memory unit 505 may be configured as two dedicated units, each configured to store a frame (e.g., two 2 Mb memories), or may be configured with shared memory 535 (e.g., memory shared between the frame memory unit 505 and the dirty bit buffer units 520).

In some embodiments, the control unit 537 may control the number of bytes in the frame memory unit 505 corresponding to each bit in a tag buffer unit 520. The control unit 537 may dynamically change the number of bytes in the frame memory unit 505 corresponding to each bit in a tag buffer unit 520 (e.g., for a new frame, changing each bit to correspond to 128 bytes instead of 64 bytes). This ability to dynamically change the correspondence ratio may, for example, be used to adapt to higher (or lower) error rates, or adapt when the decoder changes speeds.

In one embodiment, the control unit 537 may measure a variety of metrics, or may receive such measurements from other components or sources on or off a device 105-a. For example, the control unit 537 may measure or receive various measures of signal strength, such as received signal strength (RSSI), signal to noise ratio (SNR), or bit error rate (BER). The control unit 537 may also estimate, measure, or receive measurements of time between previous bursts, the training time, or certain processing times. The control unit 537 may measure or receive measurements related to velocity of the device 105-a (e.g., for a previous burst, or averaged over a series of bursts), other Doppler related metrics, location (e.g., via GPS) of the device 105-a, or orientation or position of the device. The control unit 537 may store any measurements made or received in memory 535.

The control unit 537 may use any subset of such measurements to set or change the number of bytes corresponding to each bit in a tag buffer unit 520. In some embodiments, for example, as channel conditions improve or stabilize to surpass certain thresholds, the region corresponding to each bit in the tag buffer unit 520 may increase or decrease in size (e.g., depending on the default state of the tag buffer unit 520, described below).

It is worth noting that the default state for the tag buffer unit 520 may provide an indication that there is absence of an error in a region of the frame memory unit 505 corresponding to the bit in the tag buffer unit 520. Writing to the selected memory location would, in such instances, indicate the presence of one or more errors within the corresponding region. Alternatively, the default state for the tag buffer unit 520 may provide an indication of an error in a region of the frame memory unit 505 corresponding to the bit in the tag buffer unit 520. Writing to the selected memory location would, in such instances, indicate absence of one or more errors within the corresponding region. The default state for the tag buffer unit 520 may be programmable, changing between frames. For example, when the control unit 537 measurements indicate worsening channel conditions (e.g., high velocity and low SNR surpassing a threshold), the default state may be changed to indicate an error in a region of the frame memory unit 505 corresponding to the bit in the tag buffer unit 520.

It should be noted that the size of the region corresponding to a bit in the tag buffer unit 520, and the default state of the tag buffer unit 520, may each be configurable. Thus, they may be adapted to work together to provide sufficient information at the least (or a lowered) cost in power consumption. Consider an environment wherein a measurement for the device 105-a indicates high velocity and low SNR surpassing a threshold, and the default indicates an error in a region of the frame memory unit 505. In such circumstances, the size of the region corresponding to a bit in the tag buffer unit 520 may be reduced to better identify the non-error regions. Those skilled in the art will recognize the trade offs. Varying signal quality metrics may lead to expansion or contraction of the size of the region corresponding to a bit in the tag buffer unit 520, depending on the default state of the tag buffer unit 520.

Additionally, particular units within the decoder unit 425 of FIG. 4 or 5, or the whole unit 425, may be configured to run at different speeds than other units of the device 105-a (e.g., the decoder unit 425 may be configured to run at higher speeds so that less memory will be needed). The control unit 537 (or off chip CPU or additional processing unit 430) may be configured to modify the correspondence ratio, the allocation of memory, the speeds of different units, etc., to provide for less power usage given the particular application, standard in use, error conditions, etc. Moreover, particular units within the decoder unit 425 of FIG. 4 or 5, or the whole unit 425, may be configured to power off or down between bursts or between the processing of frames. For example, the tag write unit 515 and tag buffer 520 may power off or down between frames, while the decoder unit 425 may power off or down between bursts, based on the unique reliability tagging functionality described herein.

Turning now to the interplay between the frame memory unit 505 and tag buffer unit 520, a variety of example functionality will now be discussed. In one embodiment, as the received data is placed in the frame memory unit 505, an error detection unit 510 retrieves or otherwise accesses the received data in the frame memory unit 505, and uses the CRC or other checksum to determine whether the data within the section is reliable, or contains an error. Thus, the error detection unit 510 may be configured to access a portion of the stored data in the frame memory unit 505 to search for errors within the frame. This reliability information (e.g., attributed on a per byte or per region basis) is made available to the tag write unit 515.

The tag write unit 515 may wait for the correspondence boundary (e.g., the boundary between each 64 or 128 byte region), and then may write to the tag buffer unit 520 depending on the results of the search. The tag write operation may, therefore, be based on the search of a region for errors. Whether the tag write unit 515 performs a write operation, or not, depends on the default state of the tag buffer unit 520. First, assume the default state for the tag buffer unit 520 is a “0” and provides an indication that there is absence of an error in a region of the frame memory unit 505 corresponding to the bit in the tag buffer unit 520. In such instances, if any error byte or address discontinuity is located within a region, a “1” is written to the corresponding bit in the tag buffer unit 520 (note that while in this embodiment a “1” in the tag buffer unit 520 indicates an error, the designation could be reversed). Alternatively, assume the default state for the tag buffer unit 520 is a “0” and provides an indication that there is an error in a region of the frame memory unit 505 corresponding to the bit in the tag buffer unit 520. In such instances, if any error byte or address discontinuity is located within a region, there is no write operation. If, however, there is no error byte or address discontinuity located within a region, a “1” is written to the corresponding bit in the tag buffer unit 520.

As the received data continues to be placed in the frame memory unit 505, the tagging proceeds with the tag write unit 515 accessing the reliability data and identifying regions containing error bytes or missing data as unreliable by writing (or not writing) to the corresponding bit in the tag buffer unit 520. Thus, even if only a subset of the bytes in a given region is deemed unreliable, the tag write unit 515 marks the region as unreliable If the region contains correctly received bytes, application data padding, or data after a flag, it may then be marked as reliable. Regions containing punctured data may be marked unreliable.

Once a frame is stored in the frame memory unit 505, and the tag write unit 515 has written the data based on the reliability information to the tag buffer unit 520, error correction may occur. In one embodiment, a determination is first made whether a row in the frame memory unit 505 may be processed for error correction. The decoder r/w unit 525 counts the dirty bits (i.e., reliability information) in a row of the tag buffer unit 520 (noting that each row from the tag buffer unit 520 may represent a significant number of rows in the frame memory unit). If the dirty bits in a row exceed 64, the decoder 530 may not be able to correct and may therefore typically just output the byte errors without error correction. The control unit 537 may still have knowledge about the positions of the remaining byte errors within the frame 100.

Thus, there may, also, be efficiencies in the read operations from the tag buffer unit 520. For purposes of example, assume that each bit corresponds to 64 bytes in the frame memory unit 505. The decoder r/w unit 525 may read the tag buffer unit 520 on a per byte basis, and thus with a single byte read can determine the tagging of 64 rows X 8 columns (64 bytes×8 bytes) in the frame memory unit 505.

If the number of dirty bits in a row of the tag buffer unit 520 is 64 or less, the decoder r/w unit 525 may read each corresponding row from the frame memory unit 505 and write this to the decoder 530 (noting that each bit from the dirty bit buffer unit 420 may represent a significant number of rows). The decoder 530 may correct each row with an error (rows not associated with errors are typically not sent to the RS decoder 530). Once corrected by the decoder 530, the decoder r/w unit 525 writes the corrected row back to the frame memory unit 505. Thus, the decoder 530 may be configured to correct errors in a number of rows of the frame memory unit 505, the rows selected based on an association with the region corresponding to an error indication in the tag buffer unit 520. Note that these are merely examples of a frame and the decoding processes specific thereto, and that the principles set forth herein may be applied to a variety of frame types and decoding operations.

The control unit 537 may be configured to monitor a performance time for the decoder 530. Based on this monitoring, the control unit 537 may modify a size of each of the regions in the frame memory unit 505 based at least in part on the monitored performance time. By way of example, if the decoder 530 is bogged down with excessive processing because the regions are too large, the size or the regions in the frame memory unit 505 corresponding to each bit in the tag buffer unit 520 may be reduced. This modification may also be based on the signal quality or other measurements (e.g., RSSI, SNR, BER, time between previous bursts, training time, certain processing times, velocity of the device 105, other Doppler related metrics, or location). Thus, based on the signal quality measurements and decoder 530 performance, the size or the regions in the frame memory unit 505 corresponding to each bit in the tag buffer unit 520 may be changed, as may the default state of the tag buffer unit 520. These changes may be made adaptively to optimize power consumption and reliability tagging in various environments.

Although the functionality is described above with reference to the device 105 of FIG. 1 or 4, and decoder unit 425 of FIG. 4 or 5, the functionality may be performed by a variety of other components in this or other types of devices. The functional units (e.g., RF down-conversion and filtering unit 410, A/D unit 415, demodulator unit 420, decoder unit 425, filter unit 502, frame memory unit 505, error detection unit 510, tag write unit 515, tag buffer unit 520, decoder r/w unit 525, decoder 530, and controller 537) may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. It should also be noted that although certain concepts related to sampling rate are set forth, a range of sampling techniques may be employed. Also, while examples of analog and digital filtering are used, certain functionality may be performed in the analog or digital domain.

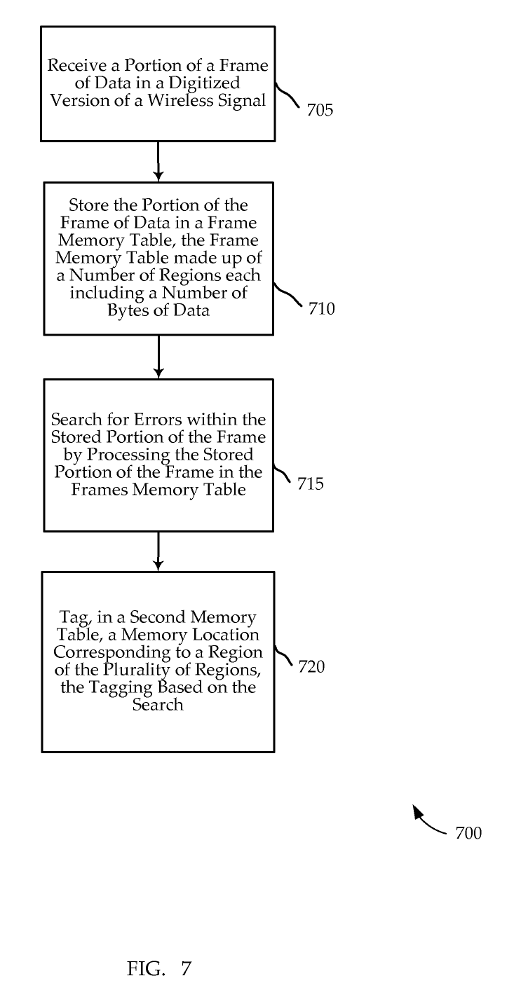

FIG. 7 is a flowchart illustrating a method 700 of error tagging according to various embodiments of the invention. The method 700 may, for example, be performed in whole or in part on the mobile communications device 105 of FIG. 1 or 4 or, more specifically, using the decoder unit 425 of FIG. 4 or 5.

At block 705, a portion of a frame of data is received in a digitized version of a wireless signal. At block 710, the portion of the frame of data is stored in a frame memory table, the frame memory table made up of a number of regions each including a number of bytes of data. At block 715, errors within the stored portion of the frame are searched for by processing the stored portion of the frame in the memory table. At block 720, in a second memory table, a memory location corresponding to a region of the plurality of regions is tagged, the tagging based on the search.

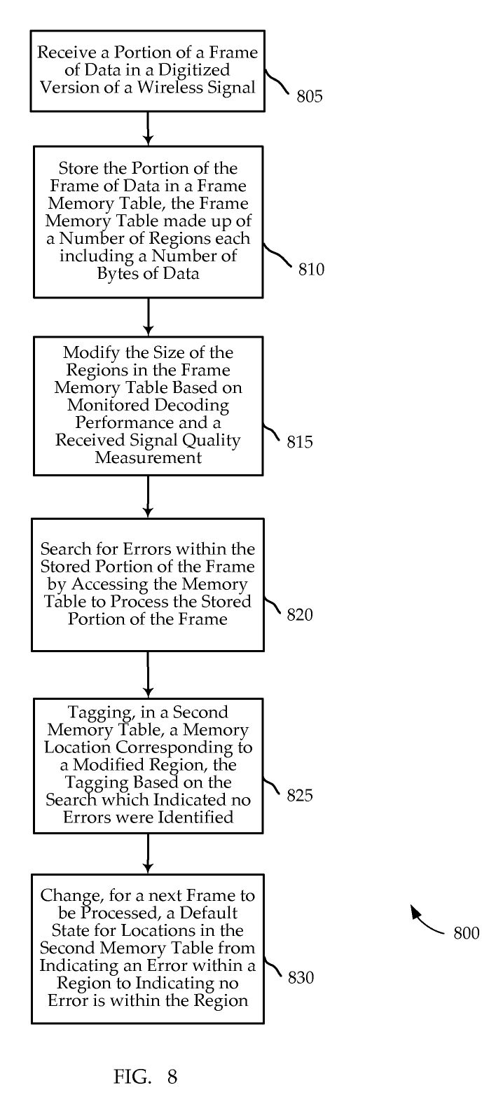

FIG. 8 is a flowchart illustrating an alternative method 800 of error tagging according to various embodiments of the invention. The method 800 may, as above, be performed in whole or in part on the mobile communications device 105 of FIG. 1 or 4 or, more specifically, using the decoder unit 425 of FIG. 4 or 5.

At block 805, a portion of a frame of data is received in a digitized version of a wireless signal. At block 810, the portion of the frame of data is stored in a frame memory table, the frame memory table made up of a number of regions each including a number of bytes of data. At block 815, the size of the regions in the frame memory table is modified based on monitored decoding performance and a received signal quality measurement.

At block 820, there is a search for errors within the stored portion of the frame which is undertaken by accessing the memory table to process the stored portion of the frame. At block 825, in a second, smaller memory table, a memory location corresponding to a modified region is tagged, the tagging based on the search which indicated no error was identified in the modified region. At block 830, for a next frame to be processed, a default state for locations in the second memory table is changed from indicating an error within a region to indicating no error is within the region.

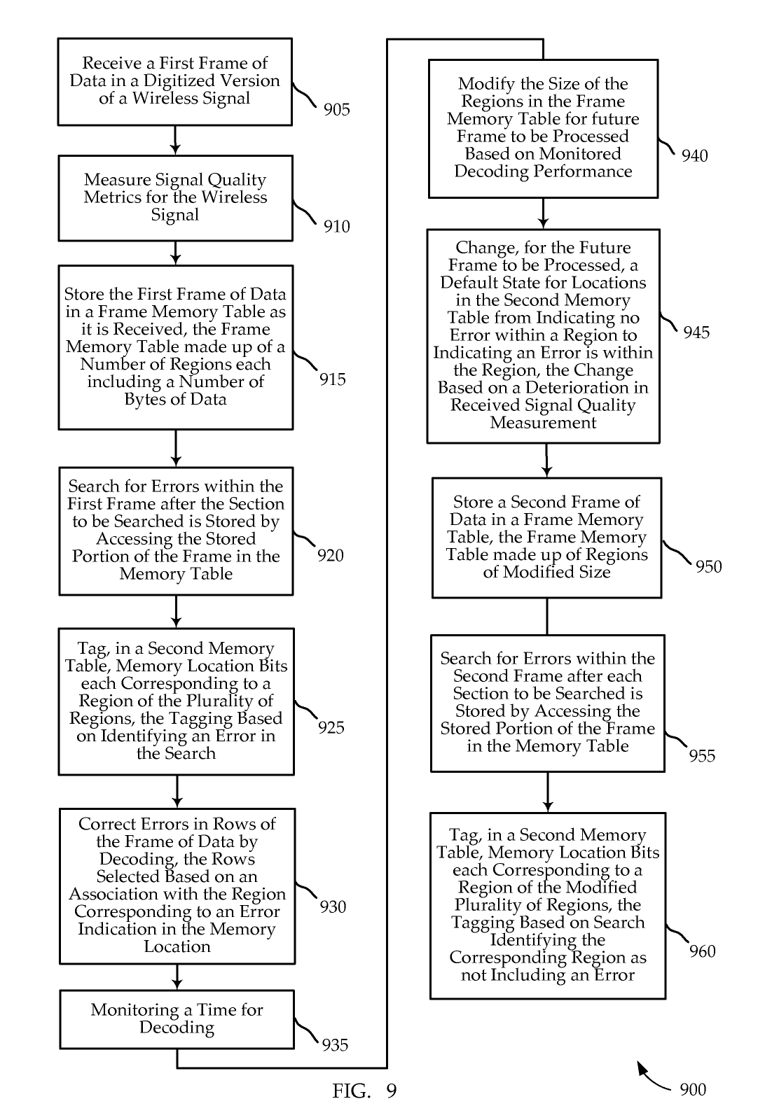

FIG. 9 is a flowchart illustrating a method 900 of error tagging for frames of encoded data according to various embodiments of the invention. The method 900 may, as above, be performed in whole or in part on the mobile communications device 105 of FIG. 1 or 4 or, more specifically, using the decoder unit 425 of FIG. 4 or 5.

At block 905, a first frame of data is received in a digitized version of a wireless signal. At block 910, signal quality metrics are measured for the wireless signal. At block 915, the first frame of data is stored in a frame memory table as it is received, the frame memory table made up of a number of regions each including a number of bytes of data.

At block 920, errors are searched for within the first frame after a section to be searched is stored, the search by accessing the stored portion of the frame in the memory table (e.g., using a checksum or CRC to detect errors). At block 925, in a second memory table, memory location bits each corresponding to a region of the plurality of regions are tagged, the tagging based on identifying an error in the search. At block 930, errors in rows of the frame of data are corrected by decoding, the rows selected based on an association with the region corresponding to an error indication in the memory location.

At block 935, decoding time is monitored or otherwise established. At block 940, the size of the regions in the frame memory table is modified for a future frame (or series of frames) to be processed, based on monitored decoding performance. At block 945, for the future frame to be processed, a default state for locations in the second memory table is changed from indicating no error within a region to indicating an error is within the region, the change based on a deterioration in received signal quality measurement.

At block 950, a second frame of data is stored in a frame memory table, the frame memory table made up of regions of modified size. At block 955, errors are searched for within the second frame after each section to be searched is stored, the search performed by accessing the stored portion of the frame in the frame memory table. At block 960, in a third memory table (of different size than the second memory table), memory location bits each corresponding to a region of the modified plurality of regions are tagged, the tagging based on search identifying the corresponding region as not including an error. There may be some physical overlap between the second and third memory tables.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A device for tagging received data for a decoder, the device comprising:
a frame memory unit comprising a plurality of regions each including memory for a plurality of bytes of data, the frame memory unit configured to store a frame of data as it is received;
an error detection unit, communicatively coupled with the frame memory unit, and configured to access a portion of the stored data in the frame memory unit to search for errors within the frame;
a tag buffer unit including a plurality of memory locations each corresponding to a different region of the plurality of regions; and
a tag write unit, communicatively coupled with the error detection unit and tag buffer unit, and configured to write to a selected memory location based at least in part on the search for a corresponding region.

2. The device of claim 1, further comprising:
a control unit, communicatively coupled with the frame memory unit, and configured to dynamically modify a size of a region of the plurality of regions in the frame memory unit corresponding to each of the memory locations.

3. The device of claim 1, further comprising:
a control unit, communicatively coupled with the frame memory unit, and configured to:
determine when a measurement of received signal quality improves above a threshold; and
increase a size of the region in the frame memory unit based on the improvement above the threshold.

4. The device of claim 1, further comprising:
a decoder unit, communicatively coupled with the frame memory unit, and configured to correct errors in a plurality of rows of the frame memory unit, the plurality of rows selected based on an association with the region corresponding to an error indication in the selected memory location.

5. The device of claim 4, further comprising:
a control unit, communicatively coupled with the frame memory unit and the decoder unit, and configured to:
monitor a performance time for the decoder unit; and
modify a size of each of the plurality of regions in the frame memory unit based at least in part on the monitored performance time.

6. The device of claim 1, wherein,
a default state for the tag buffer unit comprises an indication of an absence of an error for a region corresponding to each of the plurality of memory locations; and
the writing to the selected memory location comprises writing to the selected memory location to indicate presence of one or more errors within the corresponding region.

7. The device of claim 1, wherein,
a default state for the tag buffer unit comprises an indication of an error for a region corresponding to each of the plurality of memory locations; and
the writing to the selected memory location comprises writing to the selected memory location to indicate absence of one or more errors within the corresponding region.

8. The device of claim 7, wherein,
the tag write unit is further configured to power off or down between writing operations.

9. The device of claim 1, further comprising:
a control unit, communicatively coupled with the tag write unit, and configured to change tagging for the tag buffer unit between a default indication of an absence of one or more errors within the corresponding region and a default indication of a presence of one or more errors within the corresponding region.

10. The device of claim 9, wherein,
the control unit is configured to determine when measured signal quality metrics improve above a threshold, wherein the default indication is changed based on the improvement above the threshold.

11. The device of claim 1, wherein:
the error detection unit is further configured to:
monitor the reception of the frame of data as it is stored in the frame memory unit to identify an end of a payload for a section of the frame;
utilize a checksum or cyclic redundancy check from the section footer in searching for errors for a first portion of the frame; and
utilize a timer in identifying errors for a second portion of the frame.

12. The device of claim 1, wherein,
the device comprises a mobile communications device;
the frame is in an encoded frame of data formatted according to a digital video broadcasting standard for handheld devices; and
the searching for errors is done using a cyclic redundancy check or checksum computed for a section of data.

13. The device of claim 1, wherein the device comprises a processor.

14. A device for tagging received data for a decoder, the device comprising:
means for receiving a portion of a frame of data from a digitized version of a wireless signal;
means for storing the portion of the frame of data in a frame memory table, the frame memory table comprising a plurality of regions each including a plurality of bytes of data;
means for searching for errors within the stored portion of the frame by accessing the stored portion of the frame in the memory table for processing; and
means for tagging a memory location in a second memory table corresponding to one of the plurality of regions, the tagging based at least in part on the search.

15. The device of claim 14, further comprising:
means for dynamically modifying, based on a first set of changed received signal quality metrics, a size of the region in the first memory table corresponding to the memory location; and
means for changing, based on a second set of changed received signal quality metrics, a default tag attributed to locations in the second memory table from indicating an error within the region to indicating no error is located within the region.

16. A method of tagging received data for a decoder, the method comprising:
receiving a portion of a frame of data from a digitized version of a wireless signal;
storing the portion of the frame of data in a frame memory table, the frame memory table comprising a plurality of regions each including a plurality of bytes of data;
searching for errors within the stored portion of the frame by accessing the stored portion of the frame from the memory table for processing; and
tagging, in a second memory table, a memory location corresponding to a region of the plurality of regions, the tagging based at least in part on the search.

17. The method of claim 16, further comprising:
dynamically modifying a size of the region in the first memory table corresponding to the memory location.

18. The method of claim 16, further comprising:
determining when measured signal quality metrics improve above a threshold; and
increasing a size of the region in the frame memory table based on the improvement above the threshold.

19. The method of claim 16, further comprising:
monitoring a decoding performance time; and
modifying a size of the region in the frame memory table corresponding to the memory location based at least in part on the monitored performance.

20. The method of claim 16, further comprising:
identifying, via the searching, a selected region of the plurality of regions that includes an error, wherein the tagging comprises changing the memory location to indicate presence of one or more errors within the selected region; and
correcting errors in a plurality of rows of the frame of data corresponding to the memory location, the memory location comprising a bit of information.

21. The method of claim 16, further comprising:
identifying a selected region of the plurality of regions wherein the searching fails to identify an error,
wherein the tagging comprises changing the memory location to indicate the searching failed to identify one or more errors within the selected region.

22. The method of claim 16, further comprising:
changing a default tag attributed to locations in the second memory table from indicating an error within a region to indicating no error is located within the region.

23. The method of claim 22, further comprising:
determining when measured signal quality metrics fall below a threshold, wherein the default tag is changed based on the fall below the threshold.

24. The method of claim 16, wherein,
the frame is formatted according to digital video broadcasting standard for handheld devices;
the decoder is a Reed-Solomon decoder; and
the searching for errors is done using a cyclic redundancy check or checksum.

25. A system for tagging received data for decoding, the system comprising:
a headend unit configured to:
fill an application data table;
calculate parity data for the application data; and
transmit a wireless signal comprising at least a portion of a frame including the application data table and parity data;
a mobile communications device, in wireless communication with the headend unit, and configured to:
receive and digitize the portion of the frame of data;
store the portion of the frame of data in a frame memory table, the frame memory table comprising a plurality of regions each including a plurality of bytes of data;
search for errors within the stored portion of the frame by processing the stored portion of the frame in the frame memory table; and
tag a memory location in a second memory table corresponding to a region of the plurality of regions, the tagging based at least in part on the search.
